(19) United States
(12) Patent Application Publication
(10) Pub. No.: US 2025/0282358 A1
(43) Pub. Date: Sep. 11, 2025

(54) DRIVING CONTROL APPARATUS AND METHOD THEREOF

(71) Applicants: Hyundai Motor Company, Seoul (KR); Kia Corporation, Seoul (KR)

(72) Inventors: Ju Eun Lee, Hwaseong-Si (KR); Jeong Soo Kim, Hwaseong-Si (KR); Kyung Won Kang, Hwaseong-si (KR); Cheol Ha Lee, Hwaseong-si (KR); Su Jin Han, Hwaseong-si (KR)

(21) Appl. No.: 18/903,704

(22) Filed: Oct. 1, 2024

(30) Foreign Application Priority Data
Mar. 7, 2024 (KR) 10-2024-0032777

(51) Int. Cl. B60W 30/18

(52) U.S. Cl. CPC B60W 30/18159; B60W 30/18163; B60W 2554/4041; B60W 2554/801

(57) ABSTRACT

Disclosed is a driving control apparatus which includes a sensor device, a memory, and a controller. The driving control apparatus identifies a situation in which a lane change is required based on a driving path, while controlling a host vehicle based on the driving path, determines whether there is a need to perform biased driving, using a first distance from a lane change end point of a target lane to the host vehicle and a second distance from the lane change end point to a parked or stopped vehicle, and performs the biased driving towards the target lane, using at least one of a position of the parked or stopped vehicle, a lateral length of the parked or stopped vehicle, or a lateral distance between the parked or stopped vehicle and the host vehicle, or any combination thereof.

### CROSS-REFERENCE TO RELATED APPLICATIONS

This present application claims priority to Korean Patent Application No. 10-2024-0032777, filed Mar. 7, 2024, the entire contents of which is incorporated herein for all purposes by this reference.

### TECHNICAL FIELD

The present disclosure relates to a driving control apparatus and a method thereof, and more particularly, relates to technologies for naturally making a lane change based on a state of a parked or stopped vehicle which is present in a rightmost lane and a relationship between the parked or stopped vehicle and a host vehicle, if the host vehicle may not travel in the rightmost lane, in a situation where the host vehicle may make a right turn at an intersection.

### BACKGROUND

As an autonomous driving control technology and/or a semi-autonomous driving control technology are/is being developed, a stable driving technology for a host vehicle may gradually become more sophisticated. For example, a technology for naturally making a lane change to a target lane with regard to a surrounding situation, in a situation where the host vehicle travels at an intersection, if the host vehicle is traveling in the city center, may be developed.

Meanwhile, if performing lane change control for the host vehicle, there may be at least one other vehicle in the target lane for a lane change. For example, if the target lane is a lane (e.g., a rightmost lane) adjacent to the sidewalk, there may be a parked or stopped vehicle corresponding to a parked or stopped state in one area of the target lane. In this case, a driving system may generate a driving path for making a lane change to the target lane after the host vehicle passes through the parked or stopped vehicle.

However, in a situation where the host vehicle may make a right turn within a quick time after completing the lane change to the target lane, if the lane change is delayed due to the parked or stopped vehicle which is present in the target lane, the host vehicle may not normally make a right turn.

### SUMMARY

Aspects of the present disclosure have been described to provide solutions to the above-mentioned problems.

An aspect of the present disclosure may provide a driving control apparatus for performing biased driving control based on a state of at least one other vehicle and a driving situation of a host vehicle and then completing a lane change, if there is the at least one other vehicle in a target lane, in a driving situation in which the host vehicle may make a lane change to the target lane and make a right turn, to normally make the right turn at an intersection after the lane change is completed, and a method thereof.

Another aspect of the present disclosure may provide a driving control apparatus for determining whether each of at least one other vehicle which may be present in a target lane may be a parked or stopped vehicle based on a state, such as a speed or a position, to more accurately and quickly generate a driving path for biased driving and a lane change and a method thereof.

Another aspect of the present disclosure may provide a driving control apparatus for determining whether there is a need to perform bias driving using a distance from a last point (e.g., a lane change end point) capable of performing making a right turn in a target lane to a host vehicle and a distance from the last point to a parked or stopped vehicle and a method thereof.

Another aspect of the present disclosure may provide a driving control apparatus for previously performing biased driving and quickly entering a target lane, in a situation in which it is difficult to make a right turn after entering the target lane, because of a lack of a space in front of a parked or stopped vehicle in the target lane, to quickly make a right turn according to a driving path and a method thereof.

Another aspect of the present disclosure may provide a driving control apparatus for performing biased driving of occupying at least a portion of the target lane to indirectly provide surrounding other vehicles with an intention to make a lane change and additionally providing a driving function of finally making a lane change and completing a right turn while minimizing or reducing the influence of a rear object and a method thereof.

The technical problems to be solved by the present disclosure are not limited to the aforementioned problems, and any other technical problems not mentioned herein will be clearly understood from the following description by those skilled in the art to which the present disclosure pertains.

A driving control apparatus may comprise: a sensor device (e.g., at least one sensor); a memory storing at least one instruction; and a controller (e.g., comprising at least one processor and/or at least one vehicle controller) operatively coupled to the sensor device and the memory, wherein the at least one instruction is configured to, when executed by the controller, cause the driving control apparatus to: identify, based on a driving path, a situation in which a lane change is required for a host vehicle while controlling the host vehicle based on the driving path; based on information received from the sensor device, determine whether to perform biased driving, using a first distance from a lane change end point of a target lane to the host vehicle and a second distance from the lane change end point to a parked or stopped vehicle, wherein determining whether to perform the biased driving is based on the parked or stopped vehicle being identified in the target lane; and perform, based on a determination to perform the biased driving, the biased driving towards the target lane, using at least one of a position of the parked or stopped vehicle, a lateral length of the parked or stopped vehicle, or a lateral distance between the parked or stopped vehicle and the host vehicle, or any combination thereof.

The at least one instruction may be configured to, when executed by the controller, cause the driving control apparatus to: determine a situation in which the lane change to the target lane is required, based on: an identified intersection at which a right turn is required within a specified distance from a current position of the host vehicle, the driving path, and the host vehicle not traveling in the target lane. The lane change end point corresponds to an end point capable of making the right turn.

The at least one instruction may be configured to, when executed by the controller, cause the driving control apparatus to: based on information received from the sensor device, identify at least one other vehicle included in the target lane; and identify a first other vehicle, among the at least one other vehicle, meeting a speed condition as the parked or stopped vehicle, and wherein the first other vehicle is determined based on: a real-time driving speed of the first other vehicle being less than or equal to a first speed, or a real-time driving speed of the first other vehicle being less than or equal to a second speed greater than the first speed and a history of traveling at the first speed during a first time.

The at least one instruction may be configured to, when executed by the controller, cause the driving control apparatus to: based on information received from the sensor device, identify at least one other vehicle included in the target lane; and identify a second other vehicle, among the at least one other vehicle, meeting a position condition as the parked or stopped vehicle, and wherein the second other vehicle is determined based on: a separation distance from a right line of the target lane being less than or equal to a first value and an average driving speed of an adjacent lane being greater than or equal to a third speed, or at least part of a vehicle body of the second other vehicle passing through the right line.

The at least one instruction may be configured to, when executed by the controller, cause the driving control apparatus to: after an identification of a third other vehicle, among the at least one other vehicle, not meeting the speed condition, determine the third other vehicle as the parked or stopped vehicle, based on the third other vehicle meeting the speed condition and a position condition during a second time greater than the first time.

The at least one instruction may be configured to, when executed by the controller, cause the driving control apparatus to: after an identification of a fourth other vehicle included within a specified distance in a direction towards the host vehicle from the lane change end point, among the at least one other vehicle, determine the fourth other vehicle as the parked or stopped vehicle, based on the fourth other vehicle meeting the speed condition and a position condition during a third time greater than the first time.

The at least one instruction may be configured to, when executed by the controller, cause the driving control apparatus to: determine that there is a need to perform the biased driving, based on: the first distance from a first point of the host vehicle to the lane change end point being less than or equal to a first threshold distance; and the second distance from the lane change end point to a second point of a first parked or stopped vehicle furthest away from the host vehicle among parked or stopped vehicles including the parked or stopped vehicle being less than or equal to a second threshold distance smaller than the first threshold distance.

The at least one instruction may be configured to, when executed by the controller, cause the driving control apparatus to: identify a section corresponding to the lateral length of the parked or stopped vehicle as a biased driving maintenance section for the biased driving; identify, using the lateral distance between the parked or stopped vehicle and the host vehicle and a width of the host vehicle, an offset; identify, based on the lateral distance and the offset, a biased target lateral distance; and perform the biased driving during the biased driving maintenance section, based on a biased driving path spaced apart from the center of the parked or stopped vehicle at the biased target lateral distance.

The at least one instruction may be configured to, when executed by the controller, cause the driving control apparatus to: identify a section from a first parked or stopped vehicle furthest away from the host vehicle to a second parked or stopped vehicle closest to the host vehicle, among parked or stopped vehicles including the parked or stopped vehicle, as a biased driving maintenance section for the biased driving; identify a specified parked or stopped vehicle with a smallest lateral distance from the host vehicle among the parked or stopped vehicles; identify, using a minimum lateral distance between the specified parked or stopped vehicle and the host vehicle and a width of the host vehicle, an offset; identify, based on the minimum lateral distance and the offset, a biased target lateral distance; and perform the biased driving during the biased driving maintenance section, based on a biased driving path spaced apart from the center of the specified parked or stopped vehicle at the biased target lateral distance.

The at least one instruction may be configured to, when executed by the controller, cause the driving control apparatus to: control the host vehicle to travel adjacent to the target lane at specified lateral acceleration or less, until the host vehicle enters a starting point of a biased driving maintenance section from a time point when it is determined that there is a need to perform the biased driving; control the host vehicle to travel along a biased driving path spaced apart from the center of the parked or stopped vehicle at a biased target lateral distance, until the host vehicle overtakes the parked or stopped vehicle from the starting point of the biased driving maintenance section; and perform lane change control to the lane change end point after the host vehicle overtakes the parked or stopped vehicle.

The driving control apparatus may further perform one or more features described herein and/or may implement one or more features described herein. A driving control method may be performed by a controller of the driving control apparatus.

### BRIEF DESCRIPTION OF THE DRAWINGS

The above and other objects, features and advantages of the present disclosure will be more apparent from the following detailed description taken in conjunction with the accompanying drawings.

FIG. 1 shows an example of components of a driving control apparatus according to an example of the present disclosure.

FIG. 2 shows an example of a driving control method according to an example of the present disclosure.

FIG. 3 shows an example of an operational conceptual diagram of a driving control method according to an example of the present disclosure.

FIG. 4 shows an example of an operational conceptual diagram of a driving control method according to an example of the present disclosure.

FIG. 5 shows an example of an operational conceptual diagram of a driving control method according to an example of the present disclosure.

FIG. 6 shows an example of an operational conceptual diagram of a driving control method to an example of the present disclosure.

FIG. 7 shows an example of a flowchart showing a driving control method according to an example of the present disclosure.

FIG. 8 shows an example of a computing system about a driving control apparatus or a driving control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even if they are displayed on other drawings. In addition, a detailed description of some features or functions will be ruled out in order not to unnecessarily obscure the gist of the present disclosure.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

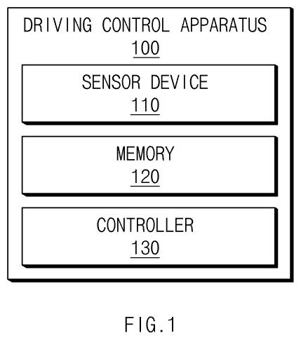

Hereinafter, examples of the present disclosure will be described in detail with reference to FIGS. 1 to 8.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

FIG. 1 is a block diagram illustrating components of a driving control apparatus according to an example of the present disclosure. Examples of an operation control for autonomous driving of a vehicle may comprise acceleration, deceleration, steering control, gear shifting control, braking system control, traction control, stability control, cruise control, lane keeping assist control, collision avoidance system control, emergency brake assistance control, traffic sign recognition control, adaptive headlight control, etc.

For example, a driving control apparatus 100 may include a sensor (e.g., camera, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.) device 110, a memory 120, and/or a controller 130. The components of the driving control apparatus 100, which are shown in FIG. 1, are illustrative, and examples of the present disclosure are not limited thereto. For example, the driving control apparatus 100 may further include components (e.g., at least one of a communication device, an interface, a display, or a notification device, or any combination thereof) which are not shown in FIG. 1.

For example, the sensor device 110 may obtain various pieces of information about a host vehicle.

For example, the sensor device 110 may include at least one sensor including at least one of a camera, radio detection and ranging (RADAR), or light detection and ranging (LiDAR), or any combination thereof.

For example, the sensor device 110 may obtain information about an external object (e.g., at least one of a person, another vehicle, a building, or a structure, or a combination thereof), using the at least one sensor.

For example, the sensor device 110 may obtain information about at least one of a real-time driving speed of a host vehicle, real-time driving acceleration of the host vehicle, a driving direction of the host vehicle, a driving path of the host vehicle, or a driving history of the host vehicle, or any combination thereof.

For example, the sensor device 110 may obtain information about at least one of a driving speed of another vehicle adjacent to the host vehicle (e.g., at least one other vehicle which is present in a target lane), driving acceleration of the other vehicle, a driving direction of the other vehicle, a driving path of the other vehicle, a type of the target lane, or a separation distance (e.g., a lateral distance and/or a longitudinal distance) between the host vehicle and the other vehicle, or any combination thereof.

For example, the sensor device 110 may obtain information about a lane in which the host vehicle is traveling and an adjacent lane adjacent to the lane (e.g., a right lane of the lane). The sensor device 110 may obtain, for example, information that there is an intersection within a specified distance in front of the lane. The sensor device 110 may check, for example, that the host vehicle may make a lane change from the lane to the target lane (e.g., the right lane of the lane) to make a right turn at the intersection.

For example, the memory 120 may store a command or data. For example, the memory 120 may store one or more instructions, if executed by the controller 130, causing the driving control apparatus 100 to perform various operations.

For example, the memory 120 and the controller 130 may be implemented as one chipset. The controller 130 may include at least one of a communication processor or a modem.

For example, the memory 120 may store various pieces of information associated with the driving control apparatus 100. For example, the memory 120 may store information about an operation history of the controller 130. For example, the memory 120 may store information associated with states and/or operations of components (e.g., at least one of an engine control unit (ECU), the sensor device 110, or the controller 130, or any combination thereof) of the host vehicle.

For example, the memory 120 may include different types of a plurality of storage devices. For example, the memory 120 may include at least one of a random-access memory (RAM) or an embedded multi-media card (eMMC), or any combination thereof.

For example, the RAM may temporarily store data (e.g., driving data) about an operation of the driving control apparatus 100 and/or the host vehicle which is a control target of the driving control apparatus 100. The RAM may include, for example, at least one buffer. The driving control apparatus 100 may store, for example, at least one node divided by dividing pieces of data collected (or identified) while performing driving control for the host vehicle by a unit time in the RAM.

For example, the eMMC may include a built-in multimedia card. The eMMC may store, for example, data for a longer time than the RAM. The eMMC may be implemented as, for example, a separate memory chip independent of the RAM.

For example, the controller 130 may be operatively connected with the sensor device 110 and/or the memory 120. For example, the controller 130 may control operations of the sensor device 110 and/or the memory 120.

For example, while controlling the host vehicle based on the driving path, the controller 130 may identify a situation in which a lane change is required based on the driving path.

For example, the controller 130 may check that there is the intersection in front of the lane in which the host vehicle is traveling, using the driving path of the host vehicle. For example, if identifying a situation in which a right turn is required at the intersection, based on the driving path, the controller 130 may determine whether the lane in which the host vehicle is traveling is a target lane capable of making a right turn (e.g., whether the lane is a rightmost lane). For example, if identifying that the host vehicle is not traveling in the target lane (e.g., if identifying that the host vehicle is traveling in a left lane of the target lane), the controller 130 may determine a situation in which a lane change to the target lane is required.

For example, the controller 130 may identify a lane change end point included in the target lane, using information received from the sensor device 110. For example, assuming that the host vehicle is traveling in the target lane, the lane change end point may be defined as a last point capable of making a right turn at the intersection.

For example, the controller 130 may identify whether there is a parked or stopped vehicle in the target lane, using information received from the sensor device 110.

For example, the controller 130 may identify at least one other vehicle included in the target lane, using information received from the sensor device 110, and may identify a first other vehicle meeting a speed condition among the at least one other vehicle as a parked or stopped vehicle. For example, the first other vehicle may include another vehicle in which a real-time driving speed is less than or equal to a first speed (e.g., 1.8 kilometers per hour (km/h)). For example, the first other vehicle may include a vehicle whose real-time driving speed may be less than or equal to a second speed (e.g., 10.8 km/h), which may be greater than the first speed, and which may have a history of traveling at the first speed during a first time (e.g., 0.8 seconds). For example, the controller 130 may determine that the other vehicle in which the real-time driving speed is less than or equal to the first speed among the at least one other vehicle corresponds to a parked or stopped vehicle meeting the speed condition. Furthermore, the controller 130 may determine that the other vehicle in which the real-time driving speed is less than or equal to the second speed and there is a history of traveling at the first speed during a time point before the first time from the current time point even once among the at least one other vehicle corresponds to the parked or stopped vehicle meeting the speed condition.

For example, the controller 130 may identify at least one other vehicle included in the target lane, using information received from the sensor device 110, and may identify a second other vehicle meeting a position condition among the at least one other vehicle as a parked or stopped vehicle. For example, the second other vehicle may include a vehicle in which a separation distance from a right line of the target lane is less than or equal to a first value (e.g., 0.3 m) and an average driving speed of an adjacent lane is greater than or equal to a third speed (e.g., 7.2 km/h). For example, the second other vehicle may include a vehicle in which at least a part of a vehicle body passes through the right line. For example, in a situation where an average driving speed of an adjacent lane of a specific vehicle (e.g., the lane of the host vehicle) is identified as being greater than or equal to the third speed, if a separation distance between the right of the specific vehicle and the right line is less than or equal to the first value, the controller 130 may determine that the specific vehicle corresponds to the parked or stopped vehicle meeting the position condition. Furthermore, the controller 130 may determine that the vehicle in which at least a part of the vehicle body passes through the right line among the at least one other vehicle corresponds to the parked or stopped vehicle meeting the position condition. In this case, the controller 130 may set the first value to be proportional to a width of the target lane. For example, if the target lane has a width greater than a predetermined width, the controller 130 may increase the first value which is a condition about a separation distance between the other vehicle and the right line.

For example, the controller 130 may identify a third other vehicle which may not meet the speed condition among the at least one other vehicle. In this case, after identifying that the third other vehicle may not meet the speed condition, if it is checked that the third other vehicle meets the speed condition and the position condition during a second time (e.g., 5 seconds) greater than the first time, the controller 130 may determine the third other vehicle as a parked or stopped vehicle.

For example, the controller 130 may identify a fourth vehicle included within a specified distance (e.g., 20 m) in a direction towards the host vehicle (e.g., the rear with respect to the other vehicle) from the lane change end point among the at least one other vehicle. For example, if it is checked that the fourth other vehicle meets the speed condition and the position condition during a third time (e.g., 10 seconds) greater than the first time, the controller 130 may determine the fourth other vehicle as a parked or stopped vehicle.

For example, the controller 130 may determine the other vehicle meeting both the position condition and the speed condition as the parked or stopped vehicle.

For example, for the other vehicle determined as the parked or stopped vehicle among the at least one other vehicle, the controller 130 may maintain the determination that the other vehicle is the parked or stopped vehicle during a predefined time (e.g., 0.8 seconds). For example, if the predefined time elapses, the controller 130 may redetermine whether each of the at least one other vehicle corresponds to the parked or stopped vehicle.

For example, if identifying that there is the at least one parked or stopped vehicle in the target lane, the controller 130 may determine whether there is a need to perform biased driving, using a first distance from the lane change end point of the target lane to the host vehicle and a second distance from the lane change end point to the parked or stopped vehicle.

For example, after identifying the lane change end point of the target lane, the controller 130 may identify the first distance which is a longitudinal distance from one component (e.g., a front bumper) of the host vehicle to the lane change end point.

For example, the controller 130 may identify the second distance which is a longitudinal distance from the lane change end point of the target lane to the parked or stopped vehicle.

For example, if the first distance is less than or equal to a first threshold distance (e.g., 100 m) and the second distance is less than or equal to a second threshold distance (e.g., 30 m) smaller than the first threshold distance, the controller 130 may determine that there is the need to perform the bias direction. For example, if the first distance is greater than the first threshold distance, the controller 130 may determine to perform the biased driving at an excessively early time point and may start to perform the biased driving at a time point if the first distance enters the first threshold distance or less. For example, if the second distance is greater than the second threshold distance, that is, if the parked or stopped vehicle is relatively far away from the lane change end point, the controller 130 may determine that it is possible to make a lane change to the target lane after the host vehicle overtakes the parked or stopped vehicle without the necessity of performing biased driving. At this time, if identifying that the second distance is less than or equal to the second threshold distance, because it is unable to be relatively easy to make a lane change to the lane change end point via normal driving as a space from the parked or stopped vehicle to the lane change end point is not wide, the controller 130 may make a lane change as quickly as possible by means of biased driving.

For example, if it is determined that there is the need to perform the bias driving, the controller 130 may perform the biased driving towards the target lane, using at least one of a position of the parked or stopped vehicle, a lateral length of the parked or stopped vehicle, or a lateral distance between the parked or stopped vehicle and the host vehicle, or any combination thereof.

For example, the controller 130 may identify the lateral length of the parked or stopped vehicle. For example, if the parked or stopped vehicle is one, the controller 130 may identify a section corresponding to the identified lateral length of the parked or stopped vehicle as a biased driving maintenance section for the biased driving. In the biased driving maintenance section, the controller 130 may control the host vehicle based on a driving path biased from a centerline of the lane to the target lane.

For example, the controller 130 may calculate an offset using the lateral distance between the parked or stopped vehicle and the host vehicle and a width of the host vehicle. For example, the offset may be a value obtained by adding the lateral distance between the parked or stopped vehicle and the host vehicle and a specified rate (e.g., 50%) of the width of the host vehicle.

For example, the controller 130 may identify a biased target lateral distance based on the lateral distance and the offset. The biased target lateral distance may be, for example, a value corresponding to a lateral distance between the center of the host vehicle and the center of the other vehicle.

For example, the controller 130 may perform biased driving control for the host vehicle during the biased driving maintenance section, based on a biased driving path spaced apart from the center of the parked or stopped vehicle at the biased target lateral distance.

For example, the controller 130 may identify a plurality of parked or stopped vehicles. In this case, the controller 130 may perform biased driving control based on relative information between the plurality of parked or stopped vehicles and the host vehicle.

For example, if identifying the plurality of parked or stopped vehicles, the controller 130 may identify a section from a first parked or stopped vehicle furthest from the host vehicle to a second parked or stopped vehicle closest to the host vehicle among the plurality of parked or stopped vehicles as the biased driving maintenance section for biased driving. For example, the controller 130 may identify a section from one component (e.g., a front bumper) of the first parked or stopped vehicle to one component (e.g., a rear bumper) of the second parked or stopped vehicle as the biased driving maintenance section.

For example, the controller 130 may identify a specified parked or stopped vehicle with the smallest lateral distance from the host vehicle among the plurality of parked or stopped vehicles. The specified parked or stopped vehicle may be the first parked or stopped vehicle or the second parked or stopped vehicle. For example, the controller 130 may calculate an offset using a lateral distance (e.g., a minimum lateral distance) between the specified parked or stopped vehicle and the host vehicle and the width of the host vehicle. For example, the offset may be a value obtained by adding the minimum lateral distance between the specified parked or stopped vehicle and the host vehicle and the specified rate (e.g., 50%) of the width of the host vehicle.

For example, the controller 130 may identify a biased target lateral distance based on the minimum lateral distance and the offset. The biased target lateral distance may be, for example, a value corresponding to a lateral distance between the center of the host vehicle and the center of the other vehicle.

For example, the controller 130 may perform biased driving control for the host vehicle during the biased driving maintenance section, based on a biased driving path spaced apart from the center of the specified parked or stopped vehicle at the biased target lateral distance.

For example, until the host vehicle enters a starting point of the biased driving maintenance section from a time point if it is determined that there is the need to perform the bias driving, the controller 130 may control the host vehicle to travel adjacent to the target lane at specified lateral acceleration or less.

For example, if it is determined that there is the need to perform the bias driving, the controller 130 may control a driving direction of the host vehicle based on lateral acceleration such that the host vehicle enters the starting point of the biased driving maintenance section. For example, the controller 130 may control the host vehicle to travel in a direction towards the target lane, using the generated lateral acceleration. For example, the controller 130 may set lateral acceleration for entering the biased driving maintenance section to a lateral acceleration limit value (e.g., 2 m/s²) or less, thus providing a user with a comfortable and stable driving experience.

For example, until the host vehicle overtakes the parked or stopped vehicle from the starting point of the biased driving maintenance section, the controller 130 may control the host vehicle to travel along the biased driving path spaced apart from the center of the parked or stopped vehicle at the biased target lateral distance. For example, the controller 130 may control driving of the host vehicle based on the biased driving path spaced apart from the center of the parked or stopped vehicle at the biased target lateral distance, from the starting point of the biased driving maintenance section to an end point of the biased driving maintenance section (e.g., one point (e.g., a front bumper) of a frontmost vehicle in the biased driving maintenance section).

For example, the controller 130 may perform lane change control to the lane change end point after the host vehicle overtakes the parked or stopped vehicle. For example, if identifying that the host vehicle overtakes the parked or stopped vehicle (or if identifying that the host vehicle passes through one point (e.g., the front bumper) of the frontmost vehicle in the biased driving maintenance section), the controller 130 may control the host vehicle to travel to the lane change end point, thus completing the lane change control.

A numerical limitation according to the above-mentioned examples is illustrative, and examples of the present disclosure are not limited thereto. For example, a numerical limitation for a threshold distance, a time, a separation distance, or the like is illustrative, which may be changed by a setting of a developer and/or a setting of the user.

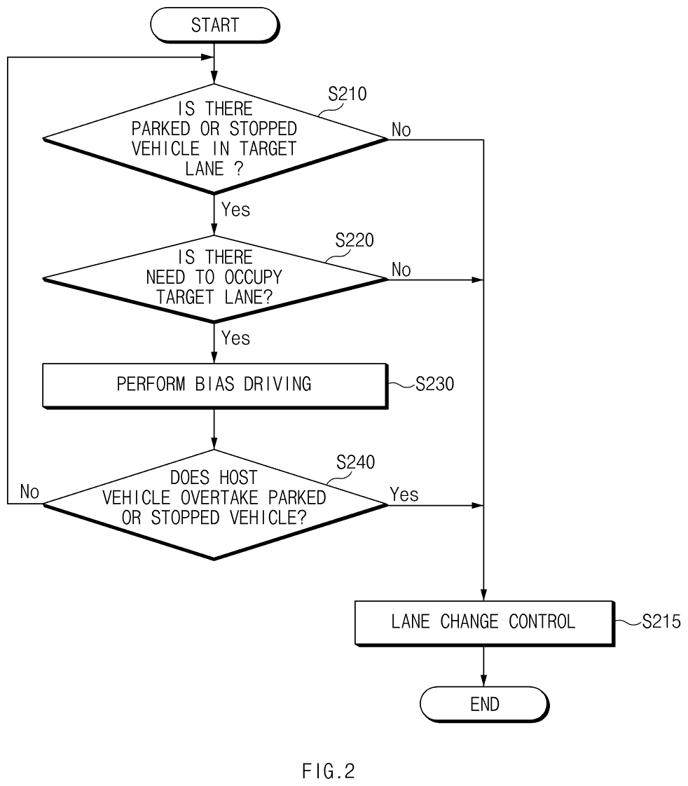

FIG. 2 shows an example of a driving control method according to an example of the present disclosure.

For example, a driving control apparatus (e.g., a driving control apparatus 100 of FIG. 1) may perform operations disclosed in FIG. 2. For example, at least some of components (e.g., a sensor device 110, a memory 120, and/or a controller 130 of FIG. 1) included in the driving control apparatus may be configured to perform the operations of FIG. 2.

Operations in S210 to S240 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 2, may be briefly described or omitted.

For example, in S210, the driving control apparatus may determine whether there is a parked or stopped vehicle in a target lane.

For example, if there is at least one other vehicle meeting a speed condition and/or a position condition in the target lane, the driving control apparatus may determine that the other vehicle is a parked or stopped vehicle.

For example, the driving control apparatus may determine the other vehicle meeting one of the speed condition and/or the position condition as the parked or stopped vehicle. For another example, the driving control apparatus may determine the other vehicle meeting both the speed condition and the position condition as the parked or stopped vehicle.

For example, if there is the parked or stopped vehicle in the target lane (e.g., S210—Yes), the vehicle control apparatus may perform S220.

For example, if there is no parked or stopped vehicle in the target lane (e.g., S210—No), the driving control apparatus may perform S215. For example, if the there is no parked or stopped vehicle in the target lane, the driving control apparatus may perform lane change control to the target lane without the necessity of considering the parked or stopped vehicle.

For example, in S220, the driving control apparatus may determine whether there is a need to occupy the target lane.

For example, if identifying that there is the parked or stopped vehicle in the target lane, the driving control apparatus may determine whether there is a need to occupy the target lane (or perform biased driving), using a first distance from a lane change end point of the target lane to the host vehicle and a second distance from the lane change end point to the parked or stopped vehicle.

For example, if there is the need to occupy the target lane (e.g., S210—Yes), the driving control apparatus may perform S230.

For example, if there is no need to occupy the target lane (e.g., S220—No), the driving control apparatus may perform S215. For example, the driving control apparatus may perform lane change control to the target lane, without performing biased driving control towards the target lane.

For example, in S230, the driving control apparatus may perform biased driving.

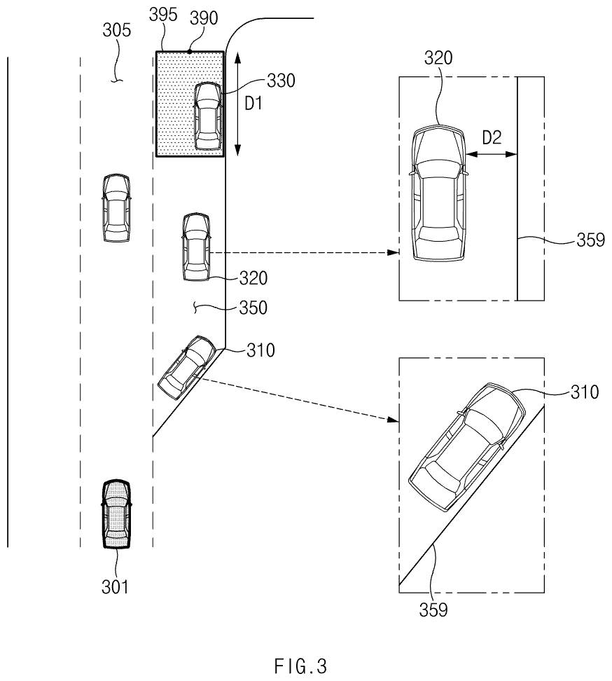

For example, the description of the biased driving control may be replaced with a description of FIGS. 3 to 6, which will be described below.

For example, in S240, the driving control apparatus may identify whether the host vehicle overtakes the parked or stopped vehicle.

For example, if the host vehicle passes through one component (e.g., a front bumper) of a frontmost parked or stopped vehicle in a biased driving maintenance section, the driving control apparatus may determine that the host vehicle overtakes the parked or stopped vehicle.

For example, if it is determined that the host vehicle overtakes the parked or stopped vehicle (e.g., S240—Yes), the driving control apparatus may perform S215.

For example, if it is determined that the host vehicle may not overtake the parked or stopped vehicle (e.g., S240—No), the driving control apparatus may repeatedly perform S210. For example, the driving control apparatus may continue performing the biased driving control until the host vehicle overtakes the parked or stopped vehicle.

For example, in S215, the driving control apparatus may perform lane change control.

For example, the driving control apparatus may control the host vehicle from the lane to the target lane. For example, the driving control apparatus may control the host vehicle to a lane change end point of the target lane to complete a lane change and may then make a right turn at an intersection.

FIG. 3 shows an example of an operational conceptual diagram of a driving control method according to an example of the present disclosure.

For example, a driving control apparatus (e.g., a driving control apparatus 100 of FIG. 1) may stably make a lane change by means of bias driving control for a host vehicle 301 and may then make a right turn at an intersection. For example, bias driving control may comprise a control strategy that may implement slight, continuous adjustments to a vehicle (e.g., a host vehicle 301)'s steering, speed, and/or positioning to ensure a smooth and stable lane change. For example, bias driving control may comprise fine-tuning the steering angle to guide the vehicle seamlessly into the adjacent lane, managing acceleration or deceleration to match the speed of the target lane, and/or ensuring the vehicle is properly aligned within the new lane, etc. For example, by using bias driving control, the vehicle may prepare effectively for subsequent maneuvers, such as making a right turn at an intersection. For example, bias driving control may enhance the stability and predictability of the vehicle's movements, contributing to safer and more efficient driving.

For example, the driving control apparatus may control the host vehicle 301 which may be traveling in a lane 305. For example, the driving control apparatus may check a situation in which there may be an intersection in front of the host vehicle 301 and there may be a need to make a right turn, based on a driving path for driving control for the host vehicle 301.

For example, the driving control apparatus may check a target lane 350 (or a rightmost lane) capable of making a right turn at the intersection. The driving control apparatus may identify, for example, at least one other vehicle (310, 320, and/or 330) which may be present in the target lane 350.

For example, the driving control apparatus may determine some other vehicles meeting a speed condition and/or a position condition among the at least one other vehicle (310, 320, and 330) as parked or stopped vehicles.

For example, the driving control apparatus may identify a parked or stopped vehicle using the speed condition. For example, the driving control apparatus may identify a vehicle in which a real-time driving speed is less than or equal to a first speed (e.g., 1.8 km/h or any other value) among the at least one other vehicle (310, 320, and 330) as another vehicle meeting the speed condition. For example, if a real-time driving speed of a specific other vehicle is less than or equal to a second speed (e.g., 10.8 km/h or any other value) greater than the first speed and there is a history of traveling at the first speed during a time point before a first time (e.g., 0.8 seconds or any other value) from a time point if the specific other vehicle is identified at least once, the driving control apparatus may identify that the specific other vehicle as the other vehicle meeting the speed condition.

For example, the driving control apparatus may determine whether the at least one other vehicle (310, 320, and 330) meets the position condition, based on a position of the at least one other vehicle (310, 320, and 330) on the target lane 350.

For example, the driving control apparatus may identify the first other vehicle 310. For example, if checking that at least a part of the vehicle body of the first other vehicle 310 passes through a right line 359 of the target lane 350, the driving control apparatus may determine that the first other vehicle 310 meets the position condition and may determine that the first other vehicle 310 may correspond to a parked or stopped vehicle.

For example, the driving control apparatus may identify the second other vehicle 320. For example, if checking that a separation distance D2 between the second other vehicle 320 and the right line 359 of the target lane 350 may be less than or equal to a first value (e.g., 0.3 m or any other value) and an average driving speed of an adjacent lane (or the lane 305) is greater than or equal to a third speed (e.g., 7.2 km/h or any other value), the driving control apparatus may determine that the second other vehicle 320 meets the position condition and may determine that the second other vehicle 320 may correspond to the parked or stopped vehicle. For example, if the target lane 350 may be wider than a predetermined width, the separation distance D2 between the second other vehicle 320 and the right line 359 of the target lane 350 may be less than or equal to a second value (e.g., 0.7 m or any other value).

For example, the driving control apparatus may identify the third other vehicle 330. For example, the driving control apparatus may check that the third other vehicle 330 is in an area 395 within a specified distance D1 (e.g., 20 m or any other value) in a direction towards the host vehicle 301 from a lane change end point 390. For example, if the third other vehicle 330 meets the speed condition and the position condition during a predefined time (e.g., 10 seconds or any other value), the driving control apparatus may determine that the third other vehicle 330 is the parked or stopped vehicle.

For example, the driving control apparatus may determine that another vehicle meeting both the speed condition and the position condition among the least one other vehicle (310, 320, and 330) is the parked or stopped vehicle. For another example, the driving control apparatus may determine another vehicle meeting one of the speed condition and/or the position condition among at least one other vehicle (310, 320, and 330) is the parked or stopped vehicle.

For example, if identifying another vehicle which may not meet the speed condition among the at least one other vehicle (310, 320, and 330) and if the identified other vehicle meets both the speed condition and the position condition during a threshold time (e.g., 5 seconds or any other value), the driving control apparatus may identify the other vehicle is the parked or stopped vehicle.

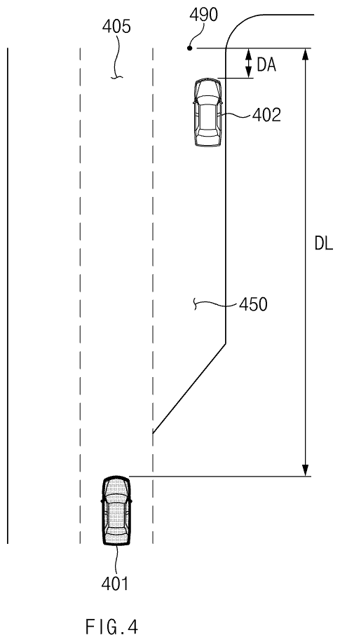

FIG. 4 shows an example of an operational conceptual diagram of a driving control method according to an example of the present disclosure.

For example, a driving control apparatus (e.g., a driving control apparatus 100 of FIG. 1) may stably make a lane change by means of bias driving control for a host vehicle 401 and may then make a right turn at an intersection.

For example, if identifying that there is a parked or stopped vehicle 402 in a target lane 450, using a sensor device (e.g., a sensor device 110 of FIG. 1), the vehicle control apparatus may determine whether there may be a need to perform biased driving, using a first distance DL from a lane change end point 490 of the target lane 450 to the host vehicle 401 and a second distance DA from the lane change end point 490 to the parked or stopped vehicle 402 shown in FIG. 4.

For example, if a plurality of parked or stopped vehicles are identified in the target lane 450, the driving control apparatus may identify a frontmost vehicle (e.g., a vehicle furthest away from the host vehicle 401) among the plurality of parked or stopped vehicles as the parked or stopped vehicle 402 shown in FIG. 4.

For example, if the first distance DL from a first point of the host vehicle 401 (e.g., a front bumper of the host vehicle 401) to the lane change end point 490 is less than or equal to a first threshold distance (e.g., 100 m or any other value) and the second distance DA from the lane change end point 490 to a second point of the parked or stopped vehicle 402 (or a vehicle furthest away from the host vehicle 401) (e.g., a front bumper of the parked or stopped vehicle 402) is less than or equal to a second threshold distance (e.g., 30 m or any other value), which is smaller than the first threshold distance, the driving control apparatus may determine that there may be the need to perform the biased driving. Additionally or alternatively, if the host vehicle 401 may change lanes, parked or stopped vehicles may start moving. In such cases, the biased lane change may be canceled, and the lane change may be made again behind the moving vehicle. For example, if the lane change to the target lane 450 has already been completed, the necessity of further action may be determined after the lane change.

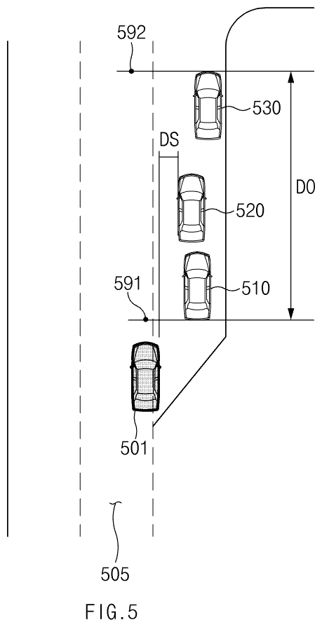

FIG. 5 shows an example of an operational conceptual diagram of a driving control method according to an example of the present disclosure.

For example, a driving control apparatus (e.g., a driving control apparatus 100 of FIG. 1) may stably make a lane change by means of bias driving control for a host vehicle 501 and may then make a right turn at an intersection.

For example, the driving control apparatus may identify at least one parked or stopped vehicle (510, 520, and 530) among at least one other vehicle included in a target lane (e.g., a right lane of a lane 505). The driving control apparatus may identify a parked or stopped vehicle, based on determination criteria according to the above-mentioned description of FIGS. 1 to 4.

For example, the driving control apparatus may identify a second point 592 corresponding to the third parked or stopped vehicle 530 which is a frontmost vehicle (e.g., a point corresponding to a front bumper of the third parked or stopped vehicle 530) from a first point 591 corresponding to the first parked or stopped vehicle 510 which is a rearmost vehicle (e.g., a point corresponding to a rear bumper of the first parked or stopped vehicle 510) among at least one parked or stopped vehicle (510, 520, and 530). The driving control apparatus may identify a section from the first point 591 to the second point 592 as a biased driving maintenance section DO.

For example, the driving control apparatus may perform biased driving control for the host vehicle 501 during the biased driving maintenance section DO. The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

For example, the driving control apparatus may identify that a vehicle with the smallest lateral distance (e.g., DS shown in FIG. 5) from the host vehicle 501 among the at least one parked or stopped vehicle (510, 520, and 530) is the second parked or stopped vehicle 520 shown in FIG. 5.

For example, the driving control apparatus may identify a minimum lateral distance DS from the side of the host vehicle 501 to the side of the second parked or stopped vehicle 520. The driving control apparatus may calculate an offset using the minimum lateral distance DS and a width of the host vehicle 501. The driving control apparatus may identify, for example, a value obtained by adding the minimum lateral distance DS and a specified rate (e.g., 50% or any other value) of the width of the host vehicle 501 as the offset.

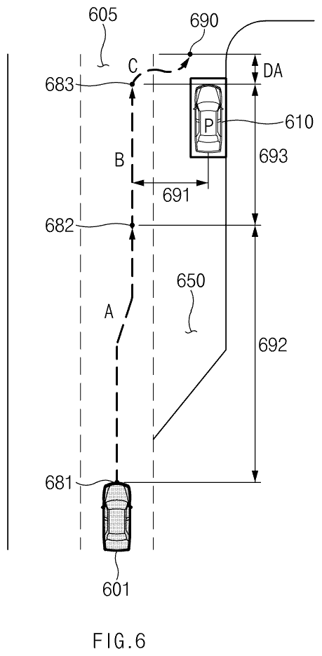

For example, the driving control apparatus may identify a biased target lateral distance based on the minimum lateral distance DS and the offset. The biased target lateral distance may be, for example, a lateral distance (e.g., a biased target lateral distance 691 of FIG. 6) from the center (or biased driving path) of the host vehicle 501 to the center of the second parked or stopped vehicle 520.

For example, the driving control apparatus may perform biased driving control during the biased driving maintenance section DO, based on a biased driving path spaced apart from the center of the second parked or stopped vehicle 520 at the biased target lateral distance.

FIG. 6 shows an example of an operational conceptual diagram of a driving control method to an example of the present disclosure.

For example, a driving control apparatus (e.g., a driving control apparatus 100 of FIG. 1) may stably make a lane change by means of bias driving control for a host vehicle 601 and may then make a right turn at an intersection.

For example, the driving control apparatus may control the host vehicle 601 to enter a biased driving path, in a following section A for biased driving.

For example, the driving control apparatus may control the host vehicle 601 to travel adjacent to a target lane 650 at specified lateral acceleration (e.g., 2 m/s² or any other value), until the host vehicle 601 enters a starting point of a biased driving maintenance section B from a time point if there is a need to perform biased driving (or a starting point 681 of section A). For example, the driving control apparatus may control the host vehicle 601 towards the target lane 650 in a lane 605, based on lateral acceleration, which is less than or equal to specified lateral acceleration. For example, the driving control apparatus may identify a longitudinal distance 692 until the host vehicle 601 enters the starting point 682 of the biased driving maintenance section B from the time point if it is determined that there may be the need to perform the bias driving, based on the calculated lateral acceleration.

For example, the driving control apparatus may perform biased driving control for the host vehicle 601 based on a biased driving path, during a biased driving distance 693 from the starting point of the biased driving maintenance section B to a starting point 683 of a lane change section C. The starting point 683 of the lane change section C may be, for example, a point at which the host vehicle 601 overtakes a parked or stopped vehicle 610 (or a frontmost vehicle among at least one parked or stopped vehicle). For example, the driving control apparatus may control the host vehicle 601 to travel along a biased driving path spaced apart from the center of the parked or stopped vehicle 610 at a biased target lateral distance 691.

For example, after the host vehicle 601 overtakes the parked or stopped vehicle 610, the driving control apparatus may perform lane change control for the host vehicle 601 to a lane change end point 690. In FIG. 6, the frontmost vehicle among the at least one parked or stopped vehicle is shown; however, the parked or stopped vehicle 610 may be plural in number. For example, a longitudinal distance DA from a front bumper of the parked or stopped vehicle 610 to the lane change end point 690 may be a second threshold distance (e.g., 30 m).

For example, the driving control apparatus may perform lane change control for the host vehicle 601 to arrive at the lane change end point 690 and may then make a right turn at the intersection.

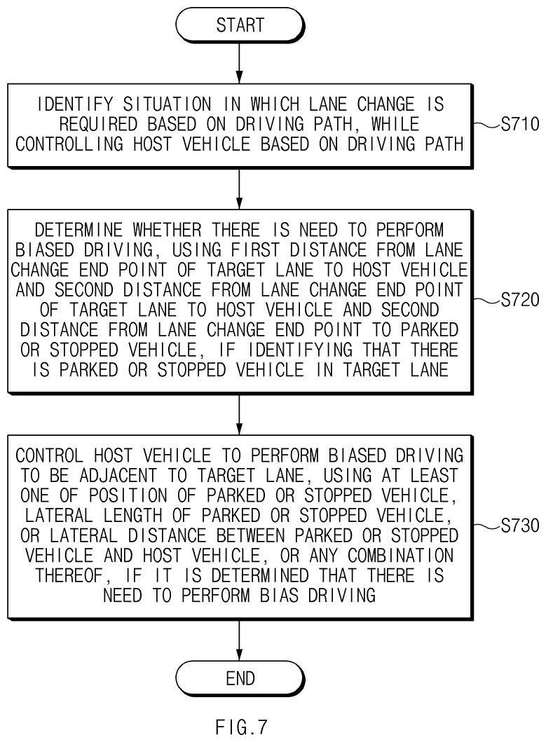

FIG. 7 shows an example of a flowchart showing a driving control method according to an example of the present disclosure.

For example, a driving control apparatus (e.g., a driving control apparatus 100 of FIG. 1) may perform operations disclosed in FIG. 7. For example, at least some of components (e.g., a sensor device 110, a memory 120, and/or a controller 130 of FIG. 1) included in the driving control apparatus may be configured to perform the operations of FIG. 7.

Operations in S710 to S730, for example, may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

For example, in S710, the driving control apparatus may identify a situation in which a lane change may be required, for example, based on a driving path, while controlling a host vehicle based on the driving path.

For example, in S720, the driving control apparatus may determine whether there may be a need to perform biased driving, using a first distance from a lane change end point of a target lane to the host vehicle and a second distance from the lane change end point to a parked or stopped vehicle, if identifying that there may be the parked or stopped vehicle in a target lane.

For example, in S730, the driving control apparatus may control the host vehicle to perform biased driving to be adjacent to the target lane, using at least one of a position of the parked or stopped vehicle, a lateral length of the parked or stopped vehicle, or a lateral distance between the parked or stopped vehicle and the host vehicle, or any combination thereof, if it is determined that there may be the need to perform the bias driving.

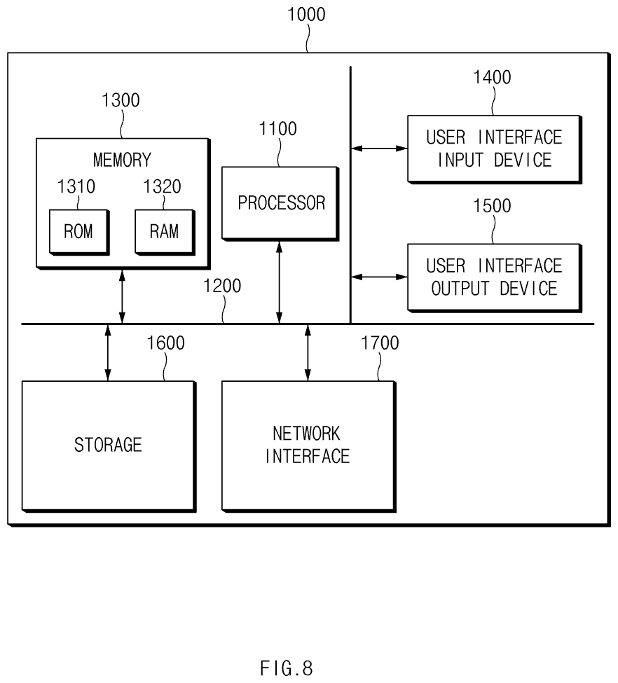

FIG. 8 shows an example of a computing system associated with a driving control apparatus or a driving control method according to an example of the present disclosure.

Referring to FIG. 8, a computing system 1000 about the driving control apparatus or the driving control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a driving control apparatus may include a sensor device, a memory storing at least one instruction, and a controller operatively connected with the sensor device and the memory. For example, the at least one instruction may be configured to, when executed by the controller, cause the driving control apparatus to identify a situation in which a lane change is required based on a driving path, while controlling a host vehicle based on the driving path, determine whether there is a need to perform biased driving, using a first distance from a lane change end point of a target lane to the host vehicle and a second distance from the lane change end point to a parked or stopped vehicle, if identifying that there is the parked or stopped vehicle in the target lane, using the sensor device, and perform the biased driving towards the target lane, using at least one of a position of the parked or stopped vehicle, a lateral length of the parked or stopped vehicle, or a lateral distance between the parked or stopped vehicle and the host vehicle, or any combination thereof, if it is determined that there is the need to perform the bias driving.

For example, the at least one instruction may be configured to, when executed by the controller, cause the driving control apparatus to determine a situation in which the lane change to the target lane is required, if identifying that there is an intersection at which a right turn is required within a specified distance from a current position of the host vehicle, based on the driving path, and that the host vehicle is not traveling in the target lane. For example, the lane change end point may correspond to an end point capable of making the right turn.

For example, the at least one instruction may be configured to, when executed by the controller, cause the driving control apparatus to identify at least one other vehicle included in the target lane, using the sensor device, and identify a first other vehicle meeting a speed condition among the at least one other vehicle as the parked or stopped vehicle. The first other vehicle may include a vehicle in which a real-time driving speed is less than or equal to a first speed or in which the real-time driving speed is less than or equal to a second speed greater than the first speed and there is a history of traveling at the first speed during a first time.

For example, the at least one instruction may be configured to, when executed by the controller, cause the driving control apparatus to identify at least one other vehicle included in the target lane, using the sensor device, and identify a second other vehicle meeting a position condition among the at least one other vehicle as the parked or stopped vehicle. For example, the second other vehicle may include a vehicle in which a separation distance from a right line of the target lane is less than or equal to a first value and an average driving speed of an adjacent lane is greater than or equal to a third speed or in which at least part of a vehicle body passes through the right line.

For example, the at least one instruction may be configured to, when executed by the controller, cause the driving control apparatus to determine a third other vehicle not meeting the speed condition among the at least one other vehicle as the parked or stopped vehicle if the third other vehicle meets the speed condition and a position condition during a second time greater than the first time, if identifying the third other vehicle.

For example, the at least one instruction may be configured to, when executed by the controller, cause the driving control apparatus to determine a fourth other vehicle included within a specified distance in a direction towards the host vehicle from the lane change end point among the at least one other vehicle as the parked or stopped vehicle if the fourth other vehicle meets the speed condition and a position condition during a third time greater than the first time, if identifying the fourth other vehicle.

For example, the at least one instruction may be configured to, when executed by the controller, cause the driving control apparatus to determine that there is the need to perform the bias driving, if the first distance from a first point of the host vehicle to the lane change end point is less than or equal to a first threshold distance and the second distance from the lane change end point to a second point of a first parked or stopped vehicle furthest away from the host vehicle among parked or stopped vehicles including the parked or stopped vehicle is less than or equal to a second threshold distance smaller than the first threshold distance.

For example, the at least one instruction may be configured to, when executed by the controller, cause the driving control apparatus to identify a section corresponding to the lateral length of the parked or stopped vehicle as a biased driving maintenance section for the biased driving, calculate an offset using the lateral distance between the parked or stopped vehicle and the host vehicle and a width of the host vehicle, identify a biased target lateral distance based on the lateral distance and the offset, and perform the biased driving during the biased driving maintenance section, based on a biased driving path spaced apart from the center of the parked or stopped vehicle at the biased target lateral distance.

For example, the at least one instruction may be configured to, when executed by the controller, cause the driving control apparatus to identify a section from a first parked or stopped vehicle furthest away from the host vehicle to a second parked or stopped vehicle closest to the host vehicle among parked or stopped vehicles including the parked or stopped vehicle as a biased driving maintenance section for the biased driving, identify a specified parked or stopped vehicle with a smallest lateral distance from the host vehicle among the parked or stopped vehicles and calculate an offset using a minimum lateral distance between the specified parked or stopped vehicle and the host vehicle and a width of the host vehicle, identify a biased target lateral distance based on the minimum lateral distance and the offset, and perform the biased driving during the biased driving maintenance section, based on a biased driving path spaced apart from the center of the specified parked or stopped vehicle at the biased target lateral distance.

For example, the at least one instruction may be configured to, when executed by the controller, cause the driving control apparatus to control the host vehicle to travel adjacent to the target lane at specified lateral acceleration or less, until the host vehicle enters a starting point of a biased driving maintenance section from a time point when it is determined that there is the need to perform the biased driving, control the host vehicle to travel along a biased driving path spaced apart from the center of the parked or stopped vehicle at a biased target lateral distance, until the host vehicle overtakes the parked or stopped vehicle from the starting point of the biased driving maintenance section, and perform lane change control to the lane change end point after the host vehicle overtakes the parked or stopped vehicle.

According to another aspect of the present disclosure, a driving control method may include identifying, by a controller, a situation in which a lane change is required based on a driving path, while controlling a host vehicle based on the driving path, determining, by the controller, whether there is a need to perform biased driving, using a first distance from a lane change end point of a target lane to the host vehicle and a second distance from the lane change end point to a parked or stopped vehicle, if identifying that there is the parked or stopped vehicle in the target lane, using a sensor device, and performing, by the controller, the biased driving towards the target lane, using at least one of a position of the parked or stopped vehicle, a lateral length of the parked or stopped vehicle, or a lateral distance between the parked or stopped vehicle and the host vehicle, or any combination thereof, if it is determined that there is the need to perform the bias driving.

For example, the driving control method may further include determining, by the controller, a situation in which the lane change to the target lane is required, if identifying that there is an intersection at which a right turn is required within a specified distance from a current position of the host vehicle, based on the driving path, and that the host vehicle is not traveling in the target lane. For example, the lane change end point may correspond to an end point capable of making the right turn.

For example, the driving control method may further include identifying, by the controller, at least one other vehicle included in the target lane, using the sensor device and identifying, by the controller, a first other vehicle meeting a speed condition among the at least one other vehicle as the parked or stopped vehicle. For example, the first other vehicle may include a vehicle in which a real-time driving speed is less than or equal to a first speed or in which the real-time driving speed is less than or equal to a second speed greater than the first speed and there is a history of traveling at the first speed during a first time.

For example, the driving control method may further include identifying, by the controller, at least one other vehicle included in the target lane, using the sensor device, and identifying, by the controller, a second other vehicle meeting a position condition among the at least one other vehicle as the parked or stopped vehicle. For example, the second other vehicle may include a vehicle in which a separation distance from a right line of the target lane is less than or equal to a first value and an average driving speed of an adjacent lane is greater than or equal to a third speed or in which at least part of a vehicle body passes through the right line.

For example, the driving control method may further include determining, by the controller, a third other vehicle not meeting the speed condition among the at least one other vehicle as the parked or stopped vehicle if the third other vehicle meets the speed condition and a position condition during a second time greater than the first time, if identifying the third other vehicle.

For example, the driving control method may further include determining, by the controller, a fourth other vehicle included within a specified distance in a direction towards the host vehicle from the lane change end point among the at least one other vehicle as the parked or stopped vehicle if the fourth other vehicle meets the speed condition and a position condition during a third time greater than the first time, if identifying the fourth other vehicle.

For example, the driving control method may further include determining, by the controller, that there is the need to perform the bias driving, if the first distance from a first point of the host vehicle to the lane change end point is less than or equal to a first threshold distance and the second distance from the lane change end point to a second point of a first parked or stopped vehicle furthest away from the host vehicle among parked or stopped vehicles including the parked or stopped vehicle is less than or equal to a second threshold distance smaller than the first threshold distance.

For example, the driving control method may further include identifying, by the controller, a section corresponding to the lateral length of the parked or stopped vehicle as a biased driving maintenance section for the biased driving, calculating, by the controller, an offset using the lateral distance between the parked or stopped vehicle and the host vehicle and a width of the host vehicle, identifying, by the controller, a biased target lateral distance based on the lateral distance and the offset, and performing, by the controller, the biased driving during the biased driving maintenance section, based on a biased driving path spaced apart from the center of the specified parked or stopped vehicle at the biased target lateral distance.

For example, the driving control method may further include identifying, by the controller, a section from a first parked or stopped vehicle furthest away from the host vehicle to a second parked or stopped vehicle closest to the host vehicle among parked or stopped vehicles including the parked or stopped vehicle as a biased driving maintenance section for the biased driving, identifying, by the controller, a specified parked or stopped vehicle with a smallest lateral distance from the host vehicle among the parked or stopped vehicles and calculating, by the controller, an offset using a minimum lateral distance between the specified parked or stopped vehicle and the host vehicle and a width of the host vehicle, identifying, by the controller, a biased target lateral distance based on the minimum lateral distance and the offset, and performing, by the controller, the biased driving during the biased driving maintenance section, based on a biased driving path spaced apart from the center of the specified parked or stopped vehicle at the biased target lateral distance.

For example, the driving control method may further include controlling, by the controller, the host vehicle to travel adjacent to the target lane at specified lateral acceleration or less, until the host vehicle enters a starting point of a biased driving maintenance section from a time point if it is determined that there is the need to perform the biased driving, controlling, by the controller, the host vehicle to travel along a biased driving path spaced apart from the center of the parked or stopped vehicle at a biased target lateral distance, until the host vehicle overtakes the parked or stopped vehicle from the starting point of the biased driving maintenance section, and performing, by the controller, lane change control to the lane change end point after the host vehicle overtakes the parked or stopped vehicle.

A description will be given of effects of the driving control apparatus and the method thereof according to an example of the present disclosure.

Examples of the present disclosure may perform biased driving control based on a state of at least one other vehicle and a driving situation of a host vehicle and may then complete a lane change, if there is the at least one other vehicle in a target lane, in a driving situation in which the host vehicle may make a lane change to the target lane and make a right turn, thus normally making the right turn at an intersection after the lane change is completed.

Examples of the present disclosure may determine whether each of at least one other vehicle which is present in the target lane is a parked or stopped vehicle based on a state such as a speed or a position, thus more accurately and quickly generating a driving path for biased driving and a lane change.

Examples of the present disclosure may determine whether there is a need to perform bias driving using a distance from a last point (e.g., a lane change end point) capable of performing making a right turn to the host vehicle and a distance from the last point to the parked or stopped vehicle.

Examples of the present disclosure may previously perform biased driving and may quickly enter the target lane, in a situation in which it is difficult to make a right turn after entering the target lane, because of a lack of a space in front of the parked or stopped vehicle in the target lane, thus quickly making a right turn according to the driving path.

Examples of the present disclosure may perform biased driving of occupying at least a portion of the target lane to indirectly provide surrounding other vehicles with an intention to make a lane change and may additionally provide a driving function of finally making a lane change and completing a right turn while minimizing or reducing the influence of a rear object.

In addition, various effects ascertained directly or indirectly through the present disclosure may be provided.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A driving control apparatus, comprising:
a sensor device;
a memory storing at least one instruction; and
a processor operatively coupled to the sensor device and the memory,
wherein the at least one instruction is configured to, when executed by the processor, cause the driving control apparatus to:
identify, based on a driving path, a situation in which a lane change is required for a host vehicle while controlling the host vehicle based on the driving path;
based on information received from the sensor device, determine whether to perform biased driving, using a first distance from a lane change end point of a target lane to the host vehicle and a second distance from the lane change end point to a parked or stopped vehicle, wherein determining whether to perform the biased driving is based on the parked or stopped vehicle being identified in the target lane; and
perform, based on a determination to perform the biased driving, the biased driving towards the target lane, using at least one of a position of the parked or stopped vehicle, a lateral length of the parked or stopped vehicle, or a lateral distance between the parked or stopped vehicle and the host vehicle, or any combination thereof.

2. The driving control apparatus of claim 1, wherein the at least one instruction is configured to, when executed by the processor, cause the driving control apparatus to:
determine a situation in which the lane change to the target lane is required, based on:
an identified intersection at which a right turn is required within a specified distance from a current position of the host vehicle,
the driving path, and
the host vehicle not traveling in the target lane, and
wherein the lane change end point corresponds to an end point capable of making the right turn.

3. The driving control apparatus of claim 1, wherein the at least one instruction is configured to, when executed by the processor, cause the driving control apparatus to:
based on information received from the sensor device, identify at least one other vehicle included in the target lane; and
identify a first other vehicle, among the at least one other vehicle, meeting a speed condition as the parked or stopped vehicle, and
wherein the first other vehicle is determined based on:
a real-time driving speed of the first other vehicle being less than or equal to a first speed, or
a real-time driving speed of the first other vehicle being less than or equal to a second speed greater than the first speed and a history of traveling at the first speed during a first time.

4. The driving control apparatus of claim 1, wherein the at least one instruction is configured to, when executed by the processor, cause the driving control apparatus to:
based on information received from the sensor device, identify at least one other vehicle included in the target lane; and
identify a second other vehicle, among the at least one other vehicle, meeting a position condition as the parked or stopped vehicle, and
wherein the second other vehicle is determined based on:
a separation distance from a right line of the target lane being less than or equal to a first value and an average driving speed of an adjacent lane being greater than or equal to a third speed, or
at least part of a vehicle body of the second other vehicle passing through the right line.

5. The driving control apparatus of claim 3, wherein the at least one instruction is configured to, when executed by the processor, cause the driving control apparatus to:
after an identification of a third other vehicle, among the at least one other vehicle, not meeting the speed condition, determine the third other vehicle as the parked or stopped vehicle, based on the third other vehicle meeting the speed condition and a position condition during a second time greater than the first time.

6. The driving control apparatus of claim 3, wherein the at least one instruction is configured to, when executed by the processor, cause the driving control apparatus to:
after an identification of a fourth other vehicle included within a specified distance in a direction towards the host vehicle from the lane change end point, among the at least one other vehicle, determine the fourth other vehicle as the parked or stopped vehicle, based on the fourth other vehicle meeting the speed condition and a position condition during a third time greater than the first time.

7. The driving control apparatus of claim 1, wherein the at least one instruction is configured to, when executed by the processor, cause the driving control apparatus to:
determine that there is a need to perform the biased driving, based on:
the first distance from a first point of the host vehicle to the lane change end point being less than or equal to a first threshold distance; and
the second distance from the lane change end point to a second point of a first parked or stopped vehicle furthest away from the host vehicle among parked or stopped vehicles including the parked or stopped vehicle being less than or equal to a second threshold distance smaller than the first threshold distance.

8. The driving control apparatus of claim 1, wherein the at least one instruction is configured to, when executed by the processor, cause the driving control apparatus to:
identify a section corresponding to the lateral length of the parked or stopped vehicle as a biased driving maintenance section for the biased driving;
identify, using the lateral distance between the parked or stopped vehicle and the host vehicle and a width of the host vehicle, an offset;
identify, based on the lateral distance and the offset, a biased target lateral distance; and
perform the biased driving during the biased driving maintenance section, based on a biased driving path spaced apart from the center of the parked or stopped vehicle at the biased target lateral distance.

9. The driving control apparatus of claim 1, wherein the at least one instruction is configured to, when executed by the processor, cause the driving control apparatus to:
identify a section from a first parked or stopped vehicle furthest away from the host vehicle to a second parked or stopped vehicle closest to the host vehicle, among parked or stopped vehicles including the parked or stopped vehicle, as a biased driving maintenance section for the biased driving;
identify a specified parked or stopped vehicle with a smallest lateral distance from the host vehicle among the parked or stopped vehicles;
identify, using a minimum lateral distance between the specified parked or stopped vehicle and the host vehicle and a width of the host vehicle, an offset;
identify, based on the minimum lateral distance and the offset, a biased target lateral distance; and
perform the biased driving during the biased driving maintenance section, based on a biased driving path spaced apart from the center of the specified parked or stopped vehicle at the biased target lateral distance.

10. The driving control apparatus of claim 1, wherein the at least one instruction is configured to, when executed by the processor, cause the driving control apparatus to:
control the host vehicle to travel adjacent to the target lane at specified lateral acceleration or less, until the host vehicle enters a starting point of a biased driving maintenance section from a time point when it is determined that there is a need to perform the biased driving;
control the host vehicle to travel along a biased driving path spaced apart from the center of the parked or stopped vehicle at a biased target lateral distance, until the host vehicle overtakes the parked or stopped vehicle from the starting point of the biased driving maintenance section; and
perform lane change control to the lane change end point after the host vehicle overtakes the parked or stopped vehicle.

11. A driving control method, comprising:
identifying, by a processor and based on a driving path, a situation in which a lane change is required for a host vehicle, while controlling the host vehicle based on the driving path;
based on information received from the sensor device, determining, by the processor, whether to perform biased driving, using a first distance from a lane change end point of a target lane to the host vehicle and a second distance from the lane change end point to a parked or stopped vehicle, wherein the determining whether to perform the biased driving is based on the parked or stopped vehicle being identified in the target lane; and
performing, by the processor and based on a determination to perform the biased driving, the biased driving towards the target lane, using at least one of a position of the parked or stopped vehicle, a lateral length of the parked or stopped vehicle, or a lateral distance between the parked or stopped vehicle and the host vehicle, or any combination thereof.

12. The driving control method of claim 11, further comprising:
determining, by the processor, a situation in which the lane change to the target lane is required, based on:
an identified intersection at which a right turn is required within a specified distance from a current position of the host vehicle,
the driving path, and
the host vehicle not traveling in the target lane, and
wherein the lane change end point corresponds to an end point capable of making the right turn.

13. The driving control method of claim 11, further comprising:
based on information received from the sensor device, identifying, by the processor, at least one other vehicle included in the target lane; and
identifying, by the processor, a first other vehicle, among the at least one other vehicle, meeting a speed condition as the parked or stopped vehicle,
wherein the first other vehicle is determined based on:
a real-time driving speed of the first other vehicle being less than or equal to a first speed, or
a real-time driving speed of the first other vehicle being less than or equal to a second speed greater than the first speed and a history of traveling at the first speed during a first time.

14. The driving control method of claim 11, further comprising:
based on information received from the sensor device, identifying, by the processor, at least one other vehicle included in the target lane; and
identifying, by the processor, a second other vehicle, among the at least one other vehicle, meeting a position condition as the parked or stopped vehicle,
wherein the second other vehicle is determined based on:
a separation distance from a right line of the target lane being less than or equal to a first value and an average driving speed of an adjacent lane being greater than or equal to a third speed, or
at least part of a vehicle body of the second other vehicle passing through the right line.

15. The driving control method of claim 13, further comprising:
after an identification of a third other vehicle, among the at least one other vehicle, not meeting the speed condition, determining, by the processor, the third other vehicle as the parked or stopped vehicle, based on the third other vehicle meeting the speed condition and a position condition during a second time greater than the first time.

16. The driving control method of claim 13, further comprising:
after an identification of a fourth other vehicle included within a specified distance in a direction towards the host vehicle from the lane change end point, among the at least one other vehicle, determining, by the processor, the fourth other vehicle as the parked or stopped vehicle, based on the fourth other vehicle meeting the speed condition and a position condition during a third time greater than the first time.

17. The driving control method of claim 11, further comprising:
determining, by the processor, that there is a need to perform the biased driving, based on:
the first distance from a first point of the host vehicle to the lane change end point being less than or equal to a first threshold distance; and
the second distance from the lane change end point to a second point of a first parked or stopped vehicle furthest away from the host vehicle among parked or stopped vehicles including the parked or stopped vehicle being less than or equal to a second threshold distance smaller than the first threshold distance.

18. The driving control method of claim 11, further comprising:
identifying, by the processor, a section corresponding to the lateral length of the parked or stopped vehicle as a biased driving maintenance section for the biased driving;
identifying, by the processor and using the lateral distance between the parked or stopped vehicle and the host vehicle and a width of the host vehicle, an offset;
identifying, by the processor and based on the lateral distance and the offset, a biased target lateral distance; and
performing, by the processor, the biased driving during the biased driving maintenance section, based on a biased driving path spaced apart from the center of a specified parked or stopped vehicle at the biased target lateral distance.

19. The driving control method of claim 11, further comprising:
identifying, by the processor, a section from a first parked or stopped vehicle furthest away from the host vehicle to a second parked or stopped vehicle closest to the host vehicle, among parked or stopped vehicles including the parked or stopped vehicle, as a biased driving maintenance section for the biased driving;
identifying, by the processor, a specified parked or stopped vehicle with a smallest lateral distance from the host vehicle among the parked or stopped vehicles;
identifying, by the processor and using a minimum lateral distance between the specified parked or stopped vehicle and the host vehicle and a width of the host vehicle, an offset;
identifying, by the processor and based on the minimum lateral distance and the offset, a biased target lateral distance; and
performing, by the processor, the biased driving during the biased driving maintenance section, based on a biased driving path spaced apart from the center of the specified parked or stopped vehicle at the biased target lateral distance.

20. The driving control method of claim 11, further comprising:
controlling, by the processor, the host vehicle to travel adjacent to the target lane at specified lateral acceleration or less, until the host vehicle enters a starting point of a biased driving maintenance section from a time point when it is determined that there is a need to perform the biased driving;
controlling, by the processor, the host vehicle to travel along a biased driving path spaced apart from the center of the parked or stopped vehicle at a biased target lateral distance, until the host vehicle overtakes the parked or stopped vehicle from the starting point of the biased driving maintenance section; and
performing, by the processor, lane change control to the lane change end point after the host vehicle overtakes the parked or stopped vehicle.
